(19) United States
(12) Patent Application Publication
(10) Pub. No.: US 2005/0061909 A1
(43) Pub. Date: Mar. 24, 2005

(54) Radio controlled helicopter

(76) Inventor: Peter R. Winston, Ordell, NJ (US)

Correspondence Address: BRUCE E. LILLING;LILLING & LILLING P.C., P.O. BOX 560, GOLDEN BRIDGE, NY, 10526, US

(21) Appl. No.: 10/915,280

(22) Filed: Aug. 10, 2004

Related U.S. Application Data
(63) Continuation-in-part of application No. 29/188,476, filed on Aug. 19, 2003.

(51) Int. Cl. B64C 27/00

(52) U.S. Cl. 244/17.19

(57) ABSTRACT

This invention relates to three features to enable radio controlled helicopters to turn more precisely. The first feature entails adding a second on-board motor so that one motor is totally dedicated for main propeller and the other for the rear rotor with an integrated circuit system, which can allow each motor to function independently from each other. Second for stability a fixed vertical triangular stabilizing fin that extends downward from the boom near the tail was added to the helicopter. The third feature, which enhances safety, is that of safety arcs that are connected to one of the blades and also to one end of the fly bars. This configuration of safety arcs is a distinguishing feature and not commonly done on other radio controlled helicopters.

### FIELD OF THE INVENTION

This invention relates to the entertainment or hobby industry and, in particular to radio controlled helicopters.

### BACKGROUND OF THE INVENTION

Since Icarus first made wings for himself, man has a strong desire to fly with the birds. Flying machines of all type have been created over the millennium with varying degrees of success. Leonardo De Vinci, while a great artist, was also known for his numerous designs of flying machines.

Balloons were an early diversion to help free man from the ground. Then, one hundred years ago, the heavier than air aircraft was born and life was never the same Today, aircrafts are ubiquitous.

Along with the love affair with flying is the equally strong desire to actually control the flying craft. Children first learn the rudimentary basics of flying with paper planes, whizzing around classrooms. Then, as they grow, balsa-wood planes become a passion.

Short of flying, the only real way to experience real control is with radio controlled aircrafts. These machines come in all shapes and sizes. As electronics have improved, so has the ability to more precisely control these flying machines. Today, many different sophisticated control units are possible, especially with advanced micro-electronics.

One of the basic difficulties with current radio controlled helicopters is that one motor controls both the main propeller and the rear rotor. For example, such a design is shown in Rehkemper (U.S. Pat. No. 6,659,395). The problem with such a design is that the main propeller and the rear rotor always rotate at proportionally the same levels. If you change the speed of one, the speed of the other changes proportionally to the same degree. As a result, turning becomes problematic and cannot be precisely controlled.

The stabilization of helicopters has been a focus for development throughout the years. Ever since their rapid development toward the end of World War II, throughout the Korean War and currently, it has been the case with full-scale (real-sized) helicopter-design that tail-boom mounted stabilizing surfaces play a vital roll in their flight characteristics. Size notwithstanding, full-scale or small-scale (models), the basic laws of aerodynamics hold true throughout.

Accordingly, it is also true that, basically, a model helicopter can reap the same desirable, flight-stabilizing benefits, as can a full-scale, when designers employ the use of one or more tail-boom mounted stabilizing flight-surfaces.

Another current problems with radio controlled helicopters is the stability of the boom.

Finally, a third problem with existing radio controlled helicopters, like Rehkemper, is the configuration of the safety arcs on the main propeller. These safety arcs are connected to the inner and outer edges of the respective blade. Such a configuration is not sturdy and is subject to frequent breakage, thereby defeating the safety purpose behind the safety arcs.

### SUMMARY OF THE INVENTION

Therefore, it is an object of this invention to provide a radio controlled helicopter, which can turn more precisely. This can be achieved by a radio controlled helicopter with two on-board motors—one for the main propeller and the other for the rear rotor.

Another object is to provide better stability during flying. This is achieved by a triangular stabilizing fin that extends downward from the boom near the tail.

In the case of the instant invention, there is a fixed vertical-fin, mounted at the end of the helicopter's tail-boom. As viewed from the rear, a fixed 5-degree off-set to the right is built into this vertical-fin. This fixed-mounted vertical-fin provides three specific benefits:
1) Takeoff yaw-dampening—to dampen the adverse-yaw-effect [a pronounced counterclockwise yaw reaction experienced by the fuselage] caused by the main-rotor's rotational-torque-inertia [clockwise] during take-off.
2) Forward flight yaw-dampening—for further yaw-stabilization during forward flight.
3) Lifting-disc-leveling—to enhance main-rotor lift through leveling effect. To put it in yet other terns, to maximize the lifting “disc-effect” by keeping the main-rotor's center-of-rotation as close to perpendicular to the earth's surface as possible.

Still another object is to enhance the safety of radio controlled helicopters. This is accomplished with safety arcs that are connected to one of the blades and also to one end of one of the fly bars.

### BRIEF DESCRIPTION OF THE DRAWINGS

FIG. 1 is a perspective view of the radio controlled helicopter of this invention.

FIG. 2 is an exploded front elevational view of same.

FIG. 3 is a broken-away right side view of same.

FIG. 4 is a top view of same.

FIG. 5 is a broken-away left side view of same.

FIG. 6 is a right side view of the tail section of the radio controlled helicopter of this invention.

FIG. 7 is a left side view of the tail section of same.

FIG. 8 is a rear view of the tail section of same.

FIG. 9 is a top view of the tail section of same.

FIG. 10 is a bottom view of the tail section of same.

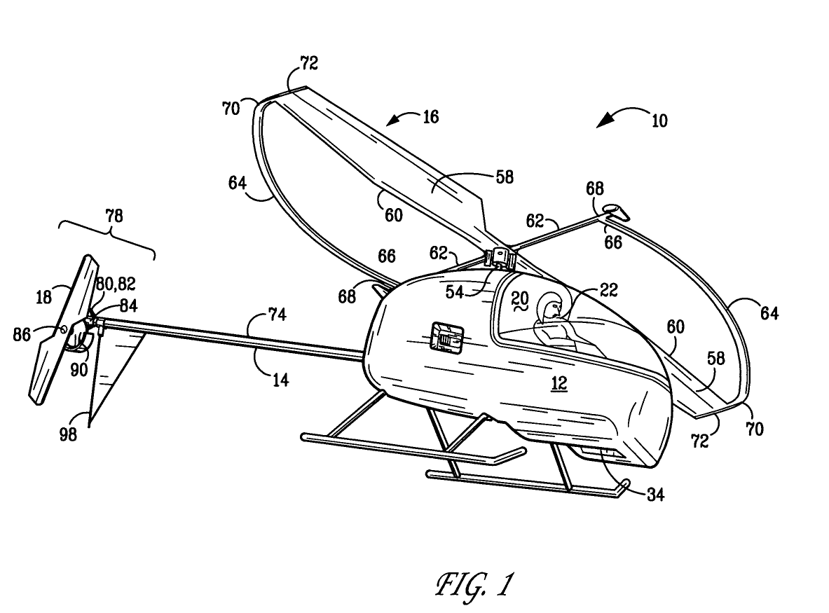

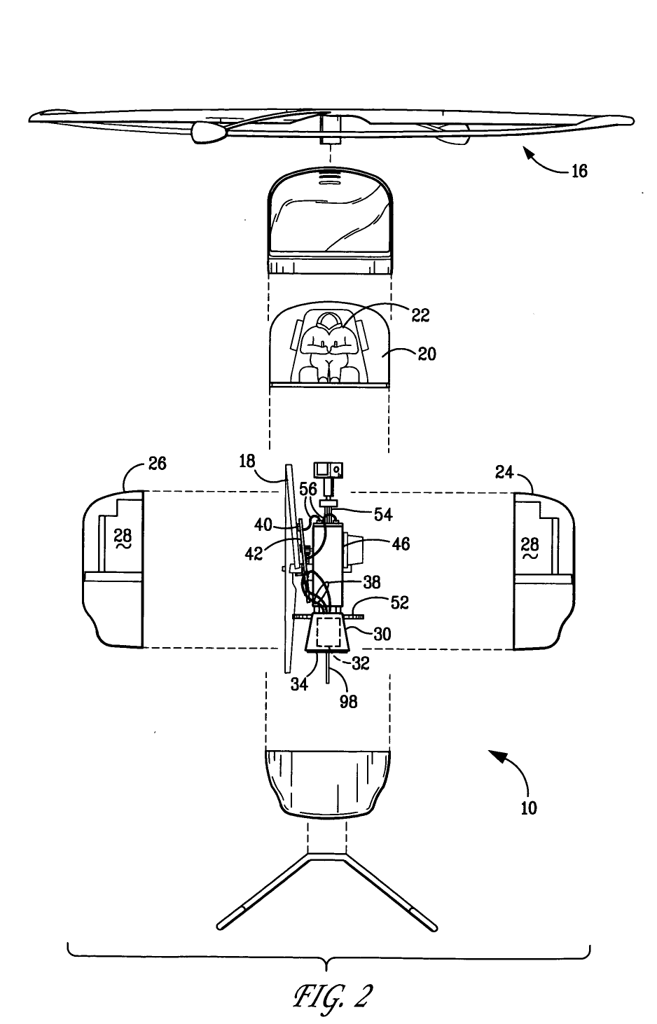

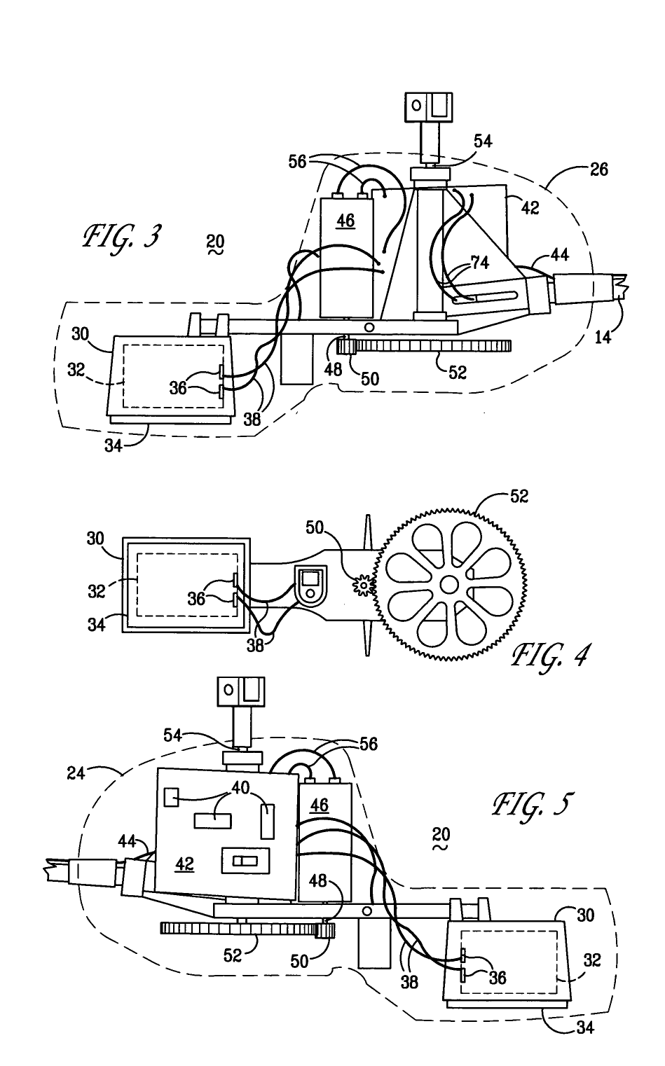

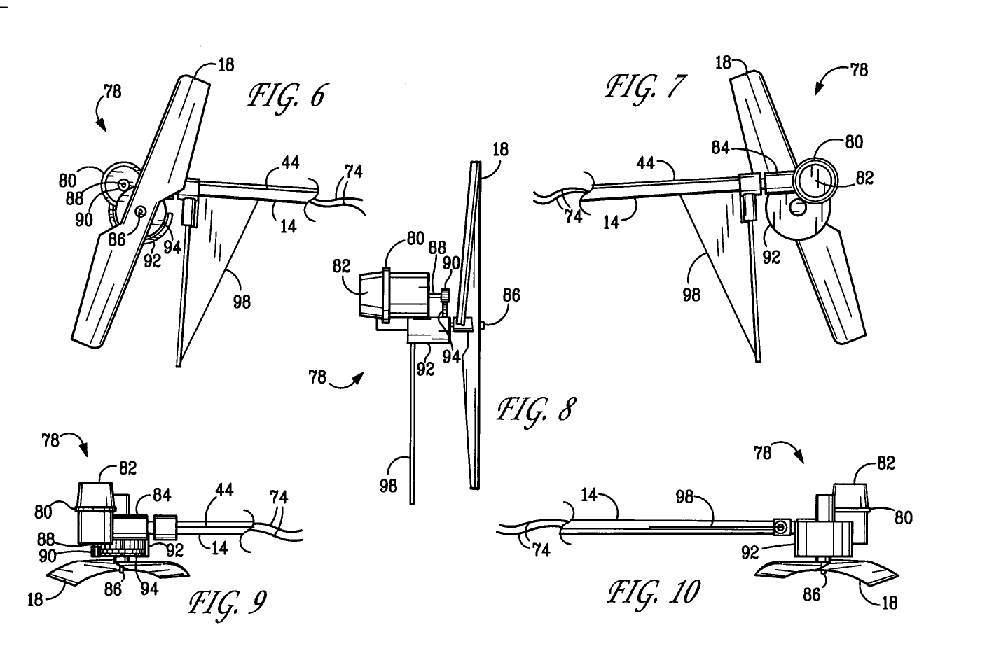

### DETAILED DESCRIPTION OF THE INVENTION

The basic radio controlled helicopter 10 of this invention has the standard helicopter features, i.e. a main body 12, a boom 14, a main propeller 16 and a rear rotor 18. Within the main body, there necessarily is a device to receive the control signals from a ground station, power means and circuitry to activate and control the main propeller and the rear rotor. Instead of having one motor to power both the main propeller and the rear rotor, there is a separate motor for each.

Based on aesthetics, the particular shape and configuration of the main body is determined. Typically, it is made to look sleek, but the invention is independent of the look, appearance and configuration. For realism, inside the cockpit 20 of the main body a model pilot 22 may be positioned.

The main body may be made of any desired material. In the preferred embodiment, a light weight material, such as styrene, is used. Such a material has sufficient sturdiness that it stays together to maintain the proper configuration of the compartment, but at the same time it is light, so as to not interfere with the flying characteristics of the craft.

As shown, the main body 12 is made of two symmetrical right and left sections 26 and 24, which fit together to define an interior chamber 28. Within the chamber 28, a housing 30 is provided to hold a suitable battery 32. A battery compartment cover 34 is accessible from the outer side of the main body 12, so the battery can be changed without disassembling the unit.

Two contact plates 36 are within the housing 30 and the terminals of the battery contact respective contact plates. In known fashion, wires 38 are connected to the respective contact plates 36 and extend out from the battery housing 30. The other ends of the wires 38 are connected to a microprocessor 40 mounted on a circuit board 42.

Arranged in any suitable manner within the chamber 28 is the circuit board 42. In the preferred embodiment, the circuit board is arranged vertically on one of the sections 24 or 26 of the main body. On the circuit board 42, an antenna 44 or other suitable means is provided to receive control signals from a ground base.

To provide power for the main propeller, a motor 46 is secured within the chamber of the main body. This motor has an output shaft 48 with a pinion gear 50. A control gear 52 meshes with the pinion gear. Attached to the hub of the control gear is an elongate drive shaft 54 which extends vertically through the main body and extends our from its top. The main propeller is mounted on the drive shaft in any known manner. Wires 56 from the microprocessor to the motor 46 control the speed of the motor and hence the speed of the propeller.

Any conventional main propeller may be used. As shown, the propeller is plastic for safety reasons.

Two blades 58 make up the propeller and each blade has a leading edge 60. For stability, fly bars 62 are included. As is commonly done, safety arcs 64 are included for each blade in front of the leading edge. A distinguishing feature of these safety arcs is that they have one end 66 attached to an outer end 68 of one of the fly bars, and the other end 70 is connected to the outer edge 72 of the respective blade. By this means, the safety arcs are made more secure and are less prone to break. In the prior art, the safety arcs are generally connected to the inner and outer ends of the blade. Such a configuration is not stable and causes the safety arcs to break prematurely and thus their purpose is defeated.

The safety arcs provide a full 360 degree balancing of the main rotor which decreases any unwanted yaw (side movement), allows more stabilized flight [owning to increased rotating mass hence increase gyroscopic stabilizing effect] and leads to more controlled flight. And, most important of all, serves to protect the end-user by lessening the chance of injury due to accidental contact while the main rotor is spinning.

While the preferred embodiment is shown with a motor, pinion gear, control gear and drive shaft for the main propeller, in fact any desirable gear train may be used. Depending on how the motor is oriented and positioned, it is even possible for the output shaft of the motor to be the actual drive shaft of the main propeller.

Also extending from the microprocessor 40 are wires 74 for the rear motor 82. These wires extend along the boom, either on the inside or along its outer surface, as desired.

On the tail assembly 78, there is a small housing 80 in which the rear motor 82 is contained. The aforesaid wires 74 connect to the rear motor and thus permit control of this motor by the microprocessor.

For balance, on the other side of the tail assembly 78, there is a rear rotor mount 84. By any suitable means, the rear motor 82 is attached to the drive shaft 86 of the rear rotor.

In the preferred embodiment, the rear motor 82 has an output shaft 88 with a pinion gear 90. As shown, the end of the output shaft with the pinion gear extends just out from the housing 80.

On the opposite side of the tail assembly a rotor housing 92 is included. Within it there is a mounting on which a control gear 94 is affixed. This control gear rotates on the outside of the housing 92 and its teeth are in mesh with the pinion gear 90. On the hub of the control gear 94 is a drive shaft 96 on which the rear rotor 18 is mounted.

For stability and greater control a triangular vertical fin 98 extends down from the boom near the tail assembly. This vertically disposed triangular tail fin 98 serves three basic purposes—to help rotation, stabilization and lift of the helicopter.

With the tail rotor 18 rotation, the vertical fin enhances the directed flow of air in a downward motion to enhance level lift of the tail section at takeoff. This works similar to pitch control of the tail fin that would need an additional channel to accomplish. The downward movement of air from the main rotor has an advantageous inverse effect. As main rotor speed increase so does the adverse torque effect, however, at the same time so does the yaw equalizing effect of the tail fin since it is set at 5-degrees offset angle. The angle can be in a range from 0 to 15 but preferably set at 5-degrees because it is most efficient set at 5-degrees. If it was set at 90-degrees it would not avail a similar effect.

On takeoff, as the main body [in a counterclockwise direction as viewed from the top] to the rotational-torque-inertia of the main rotor [spinning clockwise as view from the top] the vertical fin's 5-degree offset to the right [as viewed from the rear] reacts to the main-rotor's “prop-wash”. This “wash” pushes the tail-boom, and thus the fuselage, back in a clockwise direction thereby canceling out the main-rotor's rotational-torque-inertia which, again, is in a counterclockwise direction.

The vertical fin also affects flight during forward flight and dampens the yaw effect. While the vertical fin is offset 5-degrees, its maximum surface area is encountered when the tail boom is moved through the yaw axis either to the left or the right. Moreover, when in forward flight, the vertical-fin acts not unlike a vertical-fin in a fixed wing design aircraft. Simply put, a “weather-vane” effect is induced by the vertical-fin keeping the nose of the helicopter pointed in the direction of forward flight, while the tail trailing behind, as it should be. The vertical fin decreases lag time when rotor rpm decreases or increases for tail section rotation and induces a yaw effect for side to side movement without having any pitch control on the main rotor.

The vertical fin with bracket also assists with lifting-disc-leveling by reducing the risk of tail rotor contact on hard or non-vertical landings. This is known as a “boom-strike” in helicopter talk. A rotating prop, no matter what the diameter is, has what is called the effective “disc-area”. This disc area can be viewed when the propeller, or rotor in this case, is spinning. Fixed wings have an area and only one area. This area is calculated by multiplying the wingspan by the wing's cord. A rotary wing, or helicopter's rotor [and a conventional airplanes prop], has two differing areas. One when it is at rest, measured in the same way a fixed is, and one when it is spinning know as the disc effect. It is an accepted fact that a spinning prop at idle on a fixed wing aircraft will have a far greater brake effect that if the model's engine is stalled with the prop not moving. That is why if an aerobatic fixed-wing pilot wants more braking (throttle at idle) on the down leg of a maneuver, he will go to a larger diameter prop. The disc-effect of a helicopter, and keeping it level (or, keeping the rotor's center-of-rotation as close to perpendicular to the earth's surface as possible) is so important to the stable performance of a helicopter. With the vertical-fin of the instant invention attaching to the boom and going down, toward the ground, and not up, acts as a “third-leg” or third landing gear helping greatly to stabilize the helicopter when close to the ground and in the unpredictable state know as, “ground effect”. And, the vertical fin with bracket reduces the risk of the tail rotor coming into contact with the ground on hard or non-vertical landings.

Again to maximize the lifting “disc-effect” by keeping the main-rotor's center-of-rotation as close to perpendicular to the earth's surface as possible. Thereby, enhancing main-rotor lift through leveling effect.

“Dual motors” specifically meaning that, unlike any other helicopter of its size class, the instant invention incorporates a totally dedicated motors [each different for intended use] for both the main-rotor (mini-motor) and tail-rotor (in this case a micro-motor with integrated cooling-fin housing made from ultra lightweight aluminum alloy) use.

The dual motor design is unique that the integrated circuit system (chip program) works digitally to keep the main and tail rotor at pre set rpm's through the entire electronic speed control range, plus it has the function of decreasing or increasing the tail rotor rpm independently for steering and vertical tail movement. This unique design allows forward, left, right and yaw control with much fewer controls and allowing a beginner to fly successfully without prior knowledge of how to control a radio-controlled helicopter. In other words, the ever-changing rpm relationship to each other [main-rotor and tail-rotor motors] is simultaneously monitored and digitally synchronized to pre-set parameters throughout the entire electronic speed control range. In this way optimum stability is achieved during “hand-off” [0-input] flight operation.

Additionally, this digital-control-command program also regulates the function of increasing or decreasing the tail-rotor speed at will by the pilot controlling the transmitter. Solely pilot input at the transmitter's wheel will override the digitally-stability-control program. The amount of rpm change is predicated [linearly] on the amount of pilot wheel input at the transmitter. This facilitates independent control [by the pilot] of steering and vertical tail movement. This unique design allows control of forward, left, right and yaw with much fewer transmitter controls. Allowing a beginner to fly successfully without prior knowledge of conventional helicopter controls.

The invention is described in detail with reference to a particular embodiment, but it should be understood that various other modifications can be effected and still be within the spirit and scope of the invention.

1. A radio controlled helicopter having a main propeller and a rear rotor, and wherein the improvement comprises a first motor connected to and powering said main propeller and a second motor connected to and powering said rear rotor.

2. A radio controlled helicopter according to claim 1, further comprising a microprocessor connected to said first and second motor.

3. A radio controlled helicopter according to claim 1, further comprising a main body, wherein said main propeller is attached on a top of said main body and said first motor is mounted in said main body; and a boom, wherein said rear rotor is mounted on a tail end of said boom and said second motor is mounted on said boom near said rear rotor.

4. A radio controlled helicopter according to claim 2, further comprising a main body, wherein said main propeller is attached on a top of said main body and said first motor is mounted in said main body; and a boom, wherein said rear rotor is mounted on a tail end of said boom and said second motor is mounted on said boom near said rear rotor.

5. A radio controlled helicopter according to claim 3, further comprising a triangular stabilizing fin extending down from said boom near said rear rotor.

6. A radio controlled helicopter according to claim 5, where the stabilizing fin is vertical or offset by up to 15 degrees with respect to a vertical plane extending through said boom.

7. A radio controlled helicopter according to claim 6, where the stabilizing fin is offset 5 degrees with respect to a vertical plane extending through said boom.

8. A radio controlled helicopter according to claim 7, where the stabilizing fin is offset on a side of the boom opposite said rear rotor.

9. A radio controlled helicopter according to claim 4, further comprising a triangular stabilizing fin extending down from said boom near said rear rotor.

10. A radio controlled helicopter according to claim 9, where the stabilizing fin is vertical or offset by up to 15 degrees with respect to a vertical plane extending through said boom.

11. A radio controlled helicopter according to claim 10, where the stabilizing fin is offset 5 degrees with respect to a vertical plane extending through said boom.

12. A radio controlled helicopter according to claim 11, where the stabilizing fin is offset on a side of the boom opposite said rear rotor

13. A radio controlled helicopter according to claim 1, wherein said main propeller comprises two blades, two fly bars and two safety arcs, wherein a first end of each safety arc is connected to an outer end of a respective fly bar and a second end of each safety arc is connected to an outer end of a respective blade.

14. A radio controlled helicopter according to claim 2, wherein said main propeller comprises two blades, two fly bars and two safety arcs, wherein a first end of each safety arc is connected to an outer end of a respective fly bar and a second end of each safety arc is connected to any outer end of a respective blade.

15. A radio controlled helicopter according to claim 3, wherein said main propeller comprises two blades, two fly bars and two safety arcs, wherein a first end of each safety arc is connected to an outer end of a respective fly bar and a second end of each safety arc is connected to any outer end of a respective blade.

16. A radio controlled helicopter according to claim 4, wherein said main propeller comprises two blades, two fly bars and two safety arcs, wherein a first end of each safety arc is connected to an outer end of a respective fly bar and a second end of each safety arc is connected to any outer end of a respective blade.

17. A radio controlled helicopter according to claim 5, wherein said main propeller comprises two blades, two fly bars and two safety arcs, wherein a first end of each safety arc is connected to an outer end of a respective fly bar and a second end of each safety arc is connected to any outer end of a respective blade.

18. A radio controlled helicopter according to claim 6, wherein said main propeller comprises two blades, two fly bars and two safety arcs, wherein a first end of each safety arc is connected to an outer end of a respective fly bar and a second end of each safety arc is connected to any outer end of a respective blade.

19. A radio controlled helicopter according to claim 7, wherein said main propeller comprises two blades, two fly bars and two safety arcs, wherein a first end of each safety arc is connected to an outer end of a respective fly bar and a second end of each safety arc is connected to any outer end of a respective blade.

20. A radio controlled helicopter according to claim 8, wherein said main propeller comprises two blades, two fly bars and two safety arcs, wherein a first end of each safety arc is connected to an outer end of a respective fly bar and a second end of each safety arc is connected to any outer end of a respective blade.

21. A radio controlled helicopter according to claim 9, wherein said main propeller comprises two blades, two fly bars and two safety arcs, wherein a first end of each safety arc is connected to an outer end of a respective fly bar and a second end of each safety arc is connected to any outer end of a respective blade.

22. A radio controlled helicopter according to claim 10, wherein said main propeller comprises two blades, two fly bars and two safety arcs, wherein a first end of each safety arc is connected to an outer end of a respective fly bar and a second end of each safety arc is connected to any outer end of a respective blade.

23. A radio controlled helicopter according to claim 11, wherein said main propeller comprises two blades, two fly bars and two safety arcs, wherein a first end of each safety arc is connected to an outer end of a respective fly bar and a second end of each safety arc is connected to any outer end of a respective blade.

24. A radio controlled helicopter according to claim 12, wherein said main propeller comprises two blades, two fly bars and two safety arcs, wherein a first end of each safety arc is connected to an outer end of a respective fly bar and a second end of each safety arc is connected to any outer end of a respective blade.

25. A radio controlled helicopter comprising a main propeller and a rear rotor, and driving means connected to and powering said main propeller and said rear rotor, and wherein the improvement comprises said main propeller comprising two blades, two fly bars and two safety arcs, wherein a first end of each safety arc is connected to an outer end of a respective fly bar and a second end of each safety arc is connected to an outer end of a respective.

26. A radio controlled helicopter according to claim 25, wherein said driving means comprises a first motor connected to and powering said main propeller and a second motor connected to and powering said rear rotor.

27. A radio controlled helicopter according to claim 26, further comprising a microprocessor connected to said first and second motor

28. A radio controlled helicopter according to claim 25, further comprising a triangular stabilizing fin extending down from said boom near said rear rotor.

29. A radio controlled helicopter according to claim 26, further comprising a triangular stabilizing fin extending down from said boom near said rear rotor.

30. A radio controlled helicopter according to claim 27, further comprising a triangular stabilizing fin extending down from said boom near said rear rotor.

31. A radio controlled helicopter according to claim 28, where the stabilizing fin is vertical or offset by up to 15 degrees with respect to a vertical plane extending through said boom.

32. A radio controlled helicopter according to claim 31, where the stabilizing fin is offset 5 degrees with respect to a vertical plane extending through said boom.

33. A radio controlled helicopter according to claim 32, where the stabilizing fin is offset on a side of the boom opposite said rear rotor.

34. A radio controlled helicopter according to claim 29, where the stabilizing fin is vertical or offset by up to 15 degrees with respect to a vertical plane extending through said boom.

35. A radio controlled helicopter according to claim 34, where the stabilizing fin is offset 5 degrees with respect to a vertical plane extending through said boom.

36. A radio controlled helicopter according to claim 35, where the stabilizing fin is offset on a side of the boom opposite said rear rotor.

37. A radio controlled helicopter according to claim 30, where the stabilizing fin is vertical or offset by up to 15 degrees with respect to a vertical plane extending through said boom.

38. A radio controlled helicopter according to claim 37, where the stabilizing fin is offset 5 degrees with respect to a vertical plane extending through said boom.

39. A radio controlled helicopter according to claim 38, where the stabilizing fin is offset on a side of the boom opposite said rear rotor.

40. A propeller for use in a radio controlled helicopter comprising two blades, two fly bars and two safety arcs, wherein a first end of each safety arc is connected to an outer end of a respective fly bar and a second end of each safety arc is connected to any outer end of a respective blade.

41. A radio controlled helicopter comprising a main body, a boom, a main propeller attached on a top of said main body, a rear rotor mounted on a tail end of said boom, and driving means connected to and powering said main propeller and said rear rotor, and wherein the improvement comprises a triangular stabilizing fin extending down from said boom near said rear rotor.

42. A radio controlled helicopter according to claim 41, where the stabilizing fin is vertical or offset by up to 15 degrees with respect to a vertical plane extending through said boom.

43. A radio controlled helicopter according to claim 42, where the stabilizing fin is offset 5 degrees with respect to a vertical plane extending through said boom.

44. A radio controlled helicopter according to claim 43, where the stabilizing fin is offset on a side of the boom opposite said rear rotor.

45. A radio controlled helicopter according to claim 41, wherein said driving means comprises a first motor connected to and powering said main propeller and a second motor connected to and powering said rear rotor.

46. A radio controlled helicopter according to claim 45, further comprising a microprocessor connected to said first and second motor

47. A radio controlled helicopter according to claim 42, wherein said driving means comprises a first motor connected to and powering said main propeller and a second motor connected to and powering said rear rotor.

48. A radio controlled helicopter according to claim 47, further comprising a microprocessor connected to said first and second motor

49. A radio controlled helicopter according to claim 43, wherein said driving means comprises a first motor connected to and powering said main propeller and a second motor connected to and powering said rear rotor.

50. A radio controlled helicopter according to claim 49, further comprising a microprocessor connected to said first and second motor

51. A radio controlled helicopter according to claim 44, wherein said driving means comprises a first motor connected to and powering said main propeller and a second motor connected to and powering said rear rotor.

52. A radio controlled helicopter according to claim 51, further comprising a microprocessor connected to said first and second motor

53. A radio controlled helicopter according to claim 41, wherein said main propeller comprises two blades, two fly bars and two safety arcs, wherein a first end of each safety arc is connected to an outer end of a respective fly bar and a second end of each safety arc is connected to any outer end of a respective blade.

54. A radio controlled helicopter according to claim 42, wherein said main propeller comprises two blades, two fly bars and two safety arcs, wherein a first end of each safety arc is connected to an outer end of a respective fly bar and a second end of each safety arc is connected to any outer end of a respective blade.

55. A radio controlled helicopter according to claim 43, wherein said main propeller comprises two blades, two fly bars and two safety arcs, wherein a first end of each safety arc is connected to an outer end of a respective fly bar and a second end of each safety arc is connected to any outer end of a respective blade.

56. A radio controlled helicopter according to claim 44, wherein said main propeller comprises two blades, two fly bars and two safety arcs, wherein a first end of each safety arc is connected to an outer end of a respective fly bar and a second end of each safety arc is connected to any outer end of a respective blade.

57. A radio controlled helicopter according to claim 45, wherein said main propeller comprises two blades, two fly bars and two safety arcs, wherein a first end of each safety arc is connected to an outer end of a respective fly bar and a second end of each safety arc is connected to any outer end of a respective blade.

58. A radio controlled helicopter according to claim 46, wherein said main propeller comprises two blades, two fly bars and two safety arcs, wherein a first end of each safety arc is connected to an outer end of a respective fly bar and a second end of each safety arc is connected to any outer end of a respective blade.

59. A radio controlled helicopter according to claim 47, wherein said main propeller comprises two blades, two fly bars and two safety arcs, wherein a first end of each safety arc is connected to an outer end of a respective fly bar and a second end of each safety arc is connected to any outer end of a respective blade.

60. A radio controlled helicopter according to claim 48, wherein said main propeller comprises two blades, two fly bars and two safety arcs, wherein a first end of each safety arc is connected to an outer end of a respective fly bar and a second end of each safety arc is connected to any outer end of a respective blade.

61. A radio controlled helicopter according to claim 49, wherein said main propeller comprises two blades, two fly bars and two safety arcs, wherein a first end of each safety arc is connected to an outer end of a respective fly bar and a second end of each safety arc is connected to any outer end of a respective blade.

62. A radio controlled helicopter according to claim 50, wherein said main propeller comprises two blades, two fly bars and two safety arcs, wherein a first end of each safety arc is connected to an outer end of a respective fly bar and a second end of each safety arc is connected to any outer end of a respective blade.

63. A radio controlled helicopter according to claim 51, wherein said main propeller comprises two blades, two fly bars and two safety arcs, wherein a first end of each safety arc is connected to an outer end of a respective fly bar and a second end of each safety arc is connected to any outer end of a respective blade.

64. A radio controlled helicopter according to claim 52, wherein said main propeller comprises two blades, two fly bars and two safety arcs, wherein a first end of each safety arc is connected to an outer end of a respective fly bar and a second end of each safety arc is connected to any outer end of a respective blade.
